(19) United States
(12) Patent Application Publication
(10) Pub. No.: US 2026/0030440 A1
(43) Pub. Date: Jan. 29, 2026

(54) DATA AUGMENTATION AND FEATURE SELECTION FOR TABLE DECOMPOSITION

(71) Applicant: ADOBE INC., SAN JOSE, CA (US)

(72) Inventors: Jayant Vaibhav Srivastava, Noida (IN); Parth Shailesh Patel, Vadodara (IN); Sumit Shekhar, Noida (IN); Shubh Chaurasia, Maihar (IN); Yuvraj Raghuvanshi, Noida (IN); Jeevana Kruthi Karnuthala, Noida (IN); Paridhi Sachdeva, Noida (IN); Mohit Gupta, Noida (IN); Punit Singh, New Delhi (IN)

(21) Appl. No.: 18/782,079

(22) Filed: Jul. 24, 2024

(51) Int. Cl. G06F 40/177; G06V 30/19; G06V 30/412; G06V 30/413

(52) U.S. Cl. CPC G06F 40/177; G06V 30/19147; G06V 30/412; G06V 30/413

(57) ABSTRACT

A method comprises obtaining an unstructured document and font information for the document, wherein the unstructured document includes a table; generating location information for an element of the table based on the font information; and generating a structured representation of the table based on the location information.

### BACKGROUND

The following relates generally to document processing using both language and vision, and more specifically to extracting structured table representations from unstructured documents using machine learning. Table extraction involves identifying and extracting the structure and content of tables embedded within unstructured documents. The unstructured documents, such as PDFs, contain instructions on how to render the content on the page, but lack explicit structural information, making the table extraction of the unstructured documents challenging. Table extraction involves identifying and extracting the structure and content of tables embedded within these unstructured documents.

### SUMMARY

A method, apparatus, and non-transitory computer readable medium for language processing are described. One or more aspects of the method, apparatus, and non-transitory computer readable medium include obtaining an unstructured document and font information for the document, wherein the unstructured document includes a table; generating, using an object detection model, location information for an element of the table based on the font information; and generating a structured representation of the table based on the location information.

A method, apparatus, and non-transitory computer readable medium for language processing are described. One or more aspects of the method, apparatus, and non-transitory computer readable medium include obtaining a first training set comprising a first training document including a table with a border; training, using the first training set, an object detection model during a first training phase; obtaining a second training set comprising a second training document including the table without the border; and training, using the second training set, the object detection model during a second training phase.

An apparatus and method for language processing are described. One or more aspects of the apparatus and method include at least one processor; at least one memory storing instruction executable by the at least one processor; and an object detection model comprising parameters stored in the at least one memory and trained to generate location information for an element of a table of an unstructured document based on font information of the unstructured document.

### BRIEF DESCRIPTION OF THE DRAWINGS

FIG. 1 shows an example of a language processing system according to aspects of the present disclosure.

FIG. 2 shows an example of a language processing application according to aspects of the present disclosure.

FIG. 3 shows an example of a method for language processing according to aspects of the present disclosure.

FIG. 4 shows an example of a method for encoding font information according to aspects of the present disclosure.

FIG. 5 shows an example of a language processing apparatus according to aspects of the present disclosure.

FIG. 6 shows demonstrated results of multiple language processing methods according to aspects of the present disclosure.

FIG. 7 shows an example of a method for language processing according to aspects of the present disclosure.

FIG. 8 shows an example of a method for training a language processing model according to aspects of the present disclosure.

FIG. 9 shows an example of a computing device according to aspects of the present disclosure.

### DETAILED DESCRIPTION

The following relates generally to document processing, and more specifically to extracting structured table representations from unstructured documents using machine learning. Table extraction involves identifying and extracting the structure and content of tables embedded within unstructured documents. The unstructured documents, such as PDFs, contain instructions on how to render the content on the page, but lack explicit structural information, making the table extraction of the unstructured documents challenging.

Some methods for table extraction rely on rule-based approaches or deep learning models that treat the problem as a semantic segmentation task. Rule-based approaches struggle with complex table layouts and variations in document formatting, leading to incomplete or incorrect table extraction results. Deep learning-based methods that perform semantic segmentation may capture the overall table structure but struggle with accurately localizing individual table cells and handling complex cell arrangements, such as spanning cells or nested tables. In some cases, these methods require post-processing steps to convert pixel-level predictions into table structures, which can be computationally expensive and time-consuming.

Unstructured documents differ from structured documents in that unstructured documents do not include explicit location or structure data or metadata that specifies the location or organization of document elements such as table elements. In some cases, unstructured documents may include pixel information or information that specifies visual elements (as opposed to document elements). The lack of explicit structural information in unstructured documents, combined with the limitations of existing methods, presents challenges in accurately and efficiently extracting tables from PDF files.

Embodiments of the present disclosure model table decomposition as an object detection problem and incorporating font information to improve the accuracy of table extraction. In one aspect, embodiments of the present disclosure an object detection model to predict bounding boxes for table cells and classify the table cells as headers or non-headers, enabling a more direct and efficient approach to table decomposition. In one aspect, an additional Font-Info channel is passed as input to the object detection model, capturing font attributes of text present on the page. This Font-Info channel can be used for the model to learn to make a distinction between table header and non-header cells, because table headers may be written with distinct font attributes.

Embodiments of the present disclosure include training methods to enhance the model's performance on open and hybrid tables. The training method involves deleting horizontal and vertical lines from bordered tables to create open or hybrid table representations, effectively augmenting the training data. Unlike some approaches that use both the bordered and augmented tables in the training data, the embodiments of the present disclose include randomly selecting one bordered or augmented version of each table for training, preventing data leakage and improving the model's performance in practice. Furthermore, the method leverages the model's strong performance on bordered tables to weak-label millions of bordered tables from unlabeled PDFs. These weak-labeled tables are then augmented by deleting horizontal and vertical lines, and heuristics are employed.

Open tables refer to tables that lack explicit visual boundaries, such as borders or lines, separating the cells, and rely on the spatial arrangement of the content to imply the table structure. The absence of visible borders makes it challenging for traditional table detection and structure recognition methods to accurately identify and extract the table structure. Hybrid tables refer to tables that contain a combination of bordered and open table characteristics, with some parts of the table having explicit visual boundaries while others lack these visual cues. The presence of both bordered and open table characteristics in hybrid tables poses challenges for table detection and structure recognition algorithms, as they need to adapt to the varying visual styles within a single table.

Embodiments of the present disclosure improve the accuracy and efficiency of table extraction from unstructured documents by using an object detection model and incorporating font information. The system obtains an unstructured document along with corresponding font information, where the unstructured document includes a table. By generating location information for elements of the table using an object detection model that takes into account the font information, the system enables more accurate and fine-grained identification of table cells, headers, and other components. This is achieved by training the object detection model using a two-phase approach, where the first phase utilizes a training set with bordered tables, and the second phase employs a training set with the same tables but without borders. By combining object detection, font information, and a two-phase training approach, embodiments of the present disclosure improve the accuracy and efficiency of extracting structured table representations from unstructured documents.

In some examples, in the first training phase, the model is trained on a dataset comprising open tables (O), hybrid tables (H), and bordered tables (B), along with their augmented versions. The augmented versions are obtained by deleting horizontal lines (H), vertical lines (V), or both (H_V) from the hybrid and bordered tables, resulting in training data that includes O, H, H_H, H_V, H_H_V, B, B_H, B_V, and B_H_V. During this phase, the model (model_1) is trained on a combination of O, randomly selected versions of H (H/H_H/H_V/H_H_V), and randomly selected versions of B (B/B_H/B_V/B_H_V).

In the second training phase, model_1 is used to weak-label or infer on millions of previously unused bordered tables (B′). The augmented versions of these tables (B*) are obtained by deleting both horizontal and vertical lines. From the augmented tables (B*), a subset of tables (B_Weak) is selected based on the model's performance. The tables in B_Weak are those for which model_1 predicts with low confidence on the augmented version (B*) but with high confidence on the corresponding bordered table in B′. The second model (model_2) is then trained using B_Weak, O, randomly selected versions of H (H/H_H/H_V/H_H_V), and randomly selected versions of B (B/B_H/B_V/B_H_V). This two-phase training approach allows the model to learn from a diverse set of table structures and improve its performance on open and hybrid tables.

### Language Processing System

A method for language processing is described. One or more aspects of the method include obtaining an unstructured document and font information for the document, wherein the unstructured document includes a table; generating, using an object detection model, location information for an element of the table based on the font information; and generating a structured representation of the table based on the location information.

Some examples of the method, apparatus, and non-transitory computer readable medium further include obtaining the font information comprises performing text recognition on the unstructured document. In some aspects, the location information for the element of the table comprises a bounding box of a cell of the table.

Some examples of the method, apparatus, and non-transitory computer readable medium further include predicting, using the object detection model, a header classification for the element of the table. In some aspects, the structured representation includes row information, column information, and cell content information for the table.

Some examples of the method, apparatus, and non-transitory computer readable medium further include modifying a border of the table based on the structured representation. In some aspects, the object detection model is trained to detect table elements using a training set comprising training font information. In some aspects, the object detection model is trained to detect table elements in a first training phase using a first training set comprising a first training document including a table and in a second training phase using a second training set comprising a second training document including the table without the border.

A method for language processing is described. One or more aspects of the method include obtaining an unstructured document and font information for the document, wherein the unstructured document includes a table; generating, using an object detection model, location information for an element of the table based on the font information; and generating a structured representation of the table based on the location information.

Some examples of the method, apparatus, and non-transitory computer readable medium further include obtaining the font information comprises performing text recognition on the unstructured document. In some aspects, the location information for the element of the table comprises a bounding box of a cell of the table.

Some examples of the method, apparatus, and non-transitory computer readable medium further include predicting, using the object detection model, a header classification for the element of the table. In some aspects, the structured representation includes row information, column information, and cell content information for the table.

Some examples of the method, apparatus, and non-transitory computer readable medium further include modifying a border of the table based on the structured representation. In some aspects, the object detection model is trained to detect table elements using a training set comprising training font information. In some aspects, the object detection model is trained to detect table elements in a first training phase using a first training set comprising a first training document including a table and in a second training phase using a second training set comprising a second training document including the table without the border.

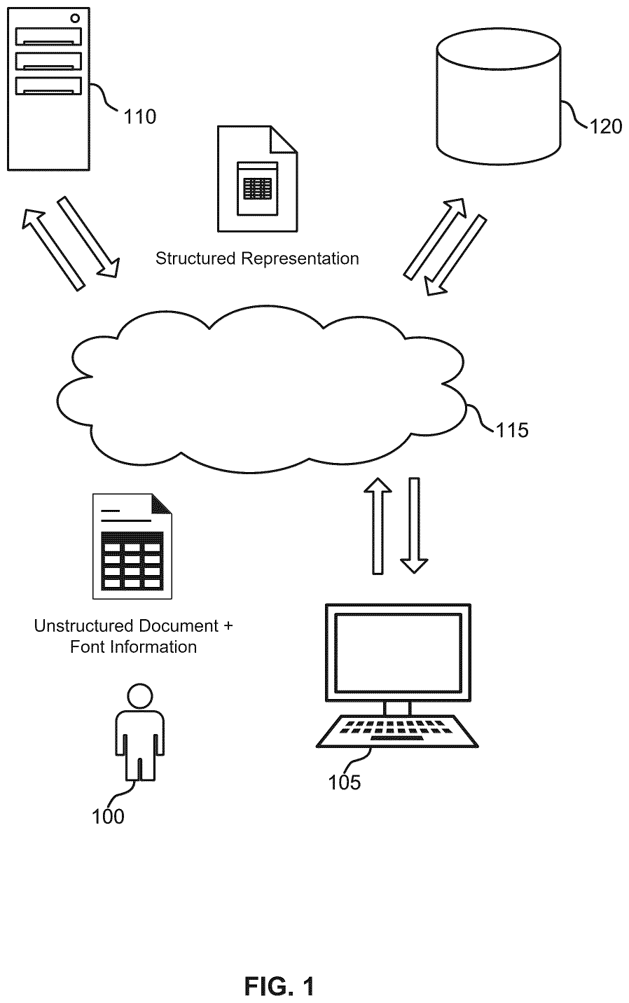

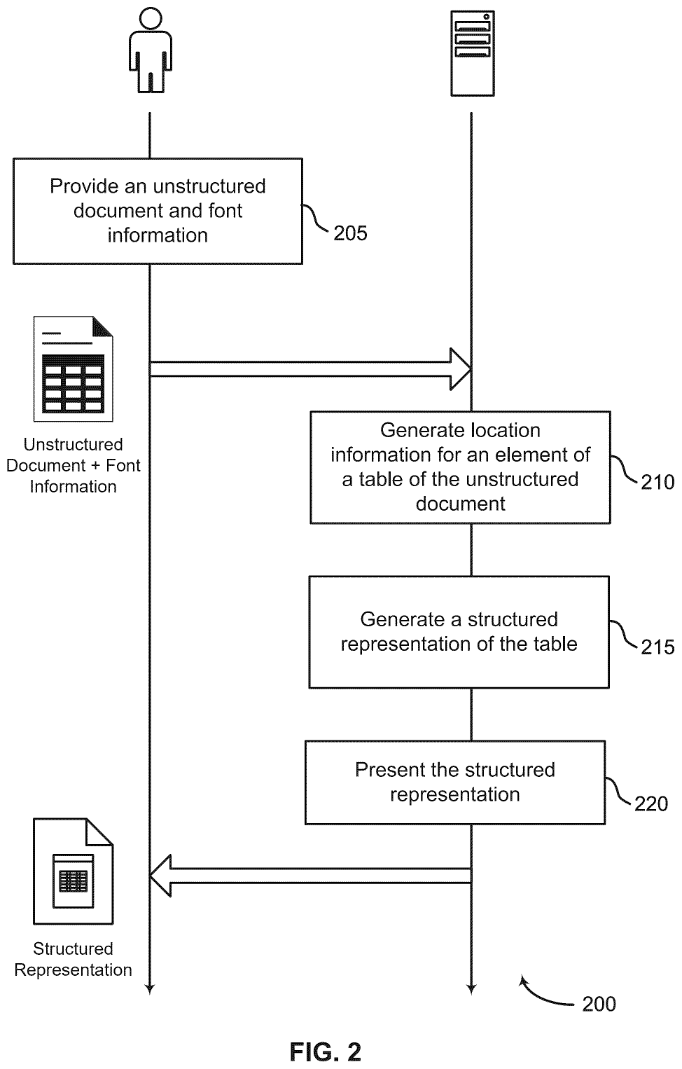

FIG. 1 shows an example of a language processing system according to aspects of the present disclosure. The language processing system is an example of, or includes aspects of, the corresponding element described with reference to FIGS. 2-6, and 9. The example shown includes user 100, user device 105, image processing apparatus 110, cloud 115, and database 120. Image processing apparatus 110 is an example of, or includes aspects of, the corresponding element described with reference to FIGS. 2-6, and 9.

In the example shown in FIG. 1, user 100 provides an unstructured document containing a table, along with the corresponding font information, to the language processing apparatus 110, e.g., via user device 105 and cloud 115. Language processing apparatus 110 then processes this input data to extract the structure and content of the table. The apparatus employs an object detection model to identify and localize table elements, generating location information in the form of bounding boxes. This location information is then passed to a table structured component, which organizes the detected elements into a logical and machine-readable format, capturing the overall structure of the table. The resulting structured representation of the table is returned to user 100 via cloud 115 and user device 105, enabling efficient data extraction and manipulation.

User device 105 may be a personal computer, laptop computer, mainframe computer, palmtop computer, personal assistant, mobile device, or any other suitable processing apparatus. In some examples, user device 105 includes software that incorporates an image processing application (e.g., query answering, image editing, relationship detection). In some examples, the image editing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code that is sent to the user device 105 and rendered locally by a browser. The process of using the image processing apparatus 110 is further described with reference to FIG. 2.

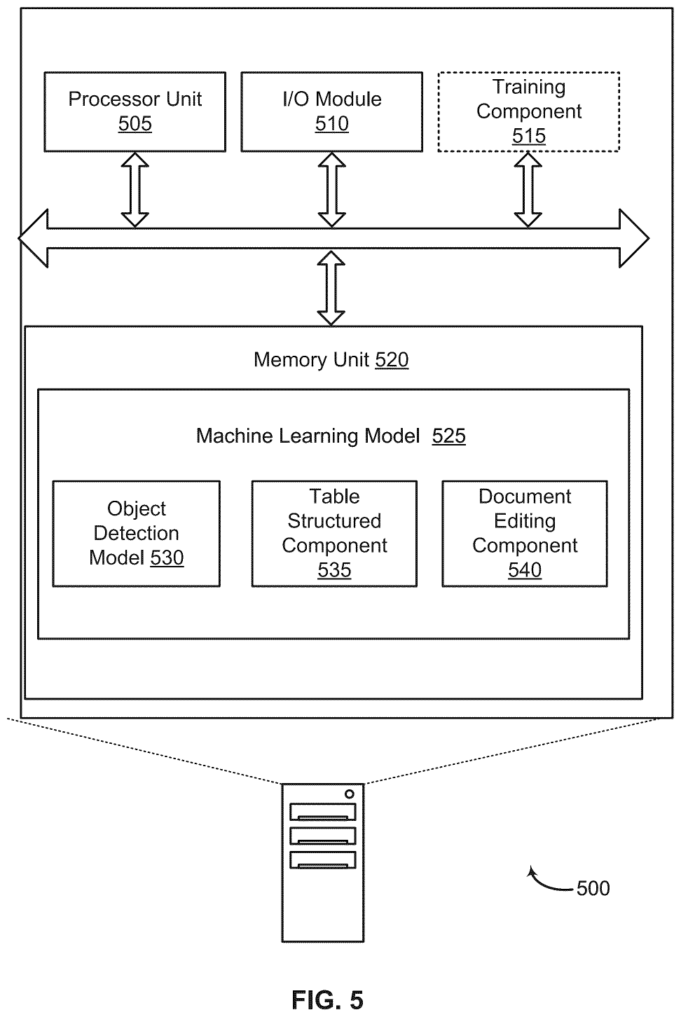

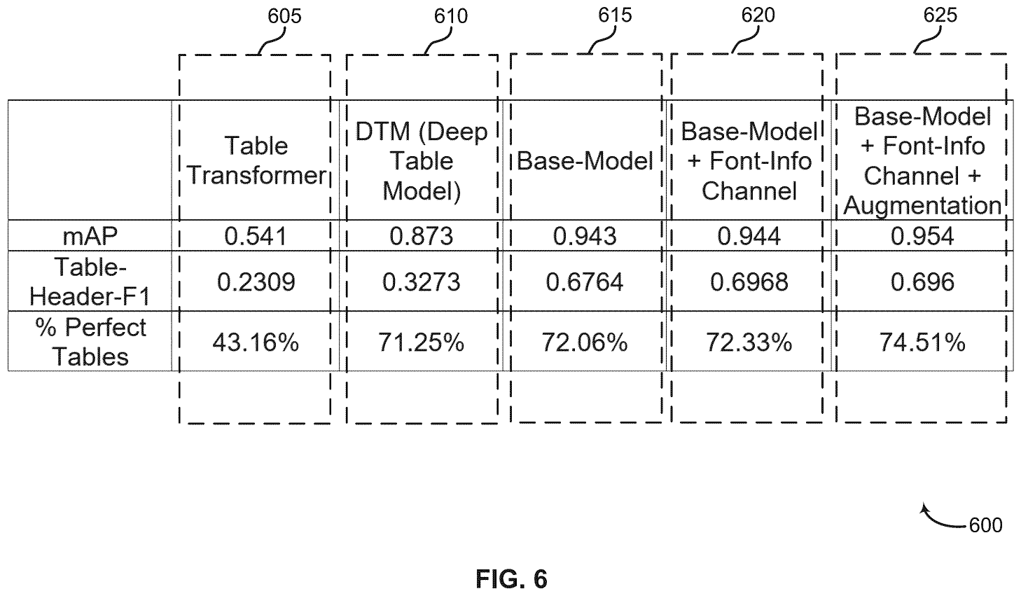

Image processing apparatus 110 includes a computer implemented network comprising an image encoder, a text encoder, a multi-modal encoder, and a decoder. Image processing apparatus 110 may also include a processor unit, a memory unit, an I/O module, and a training component. The training component is used to train a machine learning model (or an image processing network). Additionally, image processing apparatus 110 can communicate with database 120 via cloud 115. In some cases, the architecture of the image processing network is also referred to as a network, a machine learning model, or a network model. Further detail regarding the architecture of image processing apparatus 110 is provided with reference to FIGS. 5-6. Further detail regarding the operation of image processing apparatus 110 is provided with reference to FIGS. 5-6.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of a language processing application 200 according to aspects of the present disclosure. The language processing application 200 is an example of, or includes aspects of, the corresponding element described with reference to FIGS. 1, 3-6, and 9.

At operation 205, the user provides an unstructured document and font information. In some cases, the operations of this step are performed by a user as described with reference to FIG. 1. For example, in operation 205, the user inputs a PDF document containing a table, along with the corresponding font information. The PDF document lacks explicit structure and only contains instructions on how to render the content on the page. The table within the document is composed of text, lines, and whitespace, without any inherent semantic meaning or structure.

For example, the user may provide a PDF document with a table containing three lines of text and an image. The first line, “This is a sample text”, is written in Arial font. The second line, “Another sample text in italics”, is written in Times New Roman, with italicization. The third line, “A SAMPLE TEXT IN BOLD AND CAPS”, is written in Courier New, with bold formatting and capitalization. Additionally, the table includes an image of a company logo.

At operation 210, the system generates location information for an element of a table of the unstructured document. In some cases, the operations of this step are performed by an object detection model as described with reference to FIG. 5. For example, at operation 210, the system processes the PDF document and font information using an object detection model, such as YOLOX. The model analyzes the visual layout of the document, considering factors such as text placement, font attributes, and the presence of lines or whitespace. The model then predicts bounding boxes for each table cell and classifies them as either headers or regular cells.

In this example, the system generates bounding boxes for each line of text and the image. The system determines that the first line is written in Arial (the most used font in the document), the second line is in Times New Roman with italicization, and the third line is in Courier New with bold formatting and capitalization. The model also identifies the image and its location within the table. In this example, for non-scanned PDFs, the system directly extracts the font information, including the font family (e.g., Arial, Times New Roman, Courier New), font style (e.g., italicization, bold), and capitalization, for each line of text from the PDF data. In this example, this process is deterministic because the font information is explicitly available in non-scanned PDFs.

At operation 215, the system generates a structured representation of the table. In some cases, the operations of this step are performed by a table structured component as described with reference to FIG. 5. For example, at operation 215, the system takes the location information generated by the object detection model and organizes the detected table cells into a logical grid structure. The system analyzes the spatial relationships between the cells to determine the rows and columns, associates cells with corresponding headers, and handles any spanning cells.

In this example, the system creates a grid with four rows (one for each line of text and the image) and one column. The system assigns the appropriate content to each cell based on the location information provided by the object detection model, preserving the font attributes and any additional formatting.

At operation 220, the system presents the structured representation to the user. In some cases, the operations of this step are performed by a document editing component as described with reference to FIG. 5. For example, at operation 220, the system displays the structured table representation to the user through a user interface provided by the document editing component. The structured representation may enable the user to manipulate and utilize the table data extracted from the unstructured PDF document.

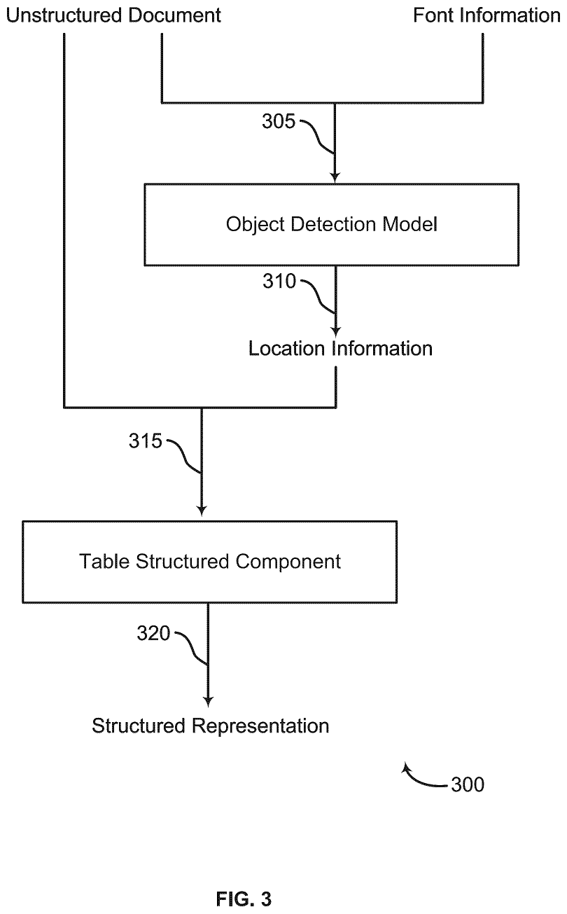

FIG. 3 shows an example of a language processing method 300 according to aspects of the present disclosure. The language processing method 300 is an example of, or includes aspects of, the corresponding element described with reference to FIGS. 1, 2, 4-6, and 9.

According to some embodiments, unstructured documents, such as PDF files, may contain instructions on how to render the content on the page, but lack structural information. For example, there are no explicit paragraphs or text lines in a PDF file, but rather a series of commands that place different characters at specific positions on the page. For example, unstructured documents may have commands to draw characters and horizontal or vertical lines, but there is no pre-existing structure of tables, such as rows, columns, or table cells, in a PDF. Embodiments of the present disclosure provide a method for extracting the structure of tables in PDF documents. The structure may be in terms of table cells, table headers, rows, and columns.

Embodiments of the present disclosure model Table Decomposition as an object detection problem, utilizing object detection models, such as YOLOX, to predict bounding boxes for Table Cells, which are further classified as headers or non-headers. In some cases, in addition to the page, text, image, and vector channels, an extra channel called the Font-Info channel may be passed as input to YOLOX. The Font-Info channel may capture font attributes of the text present on the page, which can be useful in disambiguating Table-Header from Non-Table Header cells based on that Table Headers may be written with different font attributes.

YOLO (You Only Look Once) refers to a real-time object detection algorithm. YOLO treats object detection as a regression problem, where the input image is divided into a grid, and each grid cell is responsible for predicting bounding boxes and class probabilities for the objects it contains. The architecture of YOLO comprises a convolutional neural network (CNN) backbone, followed by one or more detection heads. The backbone extracts features from the input image at different scales, while the detection heads predict bounding boxes, class probabilities, and objectness scores for each grid cell.

YOLOX refers to a modified version of YOLO. YOLOX builds upon the success of its predecessors by introducing several architectural and training enhancements. For example, YOLOX uses a decoupled head for classification and localization, which allows for more flexible and accurate predictions. The decoupled head comprises separate branches for predicting class probabilities and bounding box coordinates, enabling the model to better handle objects of different sizes and aspect ratios. In some examples, YOLOX adopts an anchor-free detection scheme, which eliminates the need for predefined anchor boxes and reduces the complexity of the model. The backbone network in YOLOX may be optimized for efficiency, utilizing techniques like channel attention and spatial attention to improve feature representation while maintaining a low computational cost.

Referring to FIG. 3, at operation 305, an unstructured document and its corresponding font information are provided as input to the object detection model. The object detection model then generates location information based on the input at operation 310. Subsequently, at operation 315, the location information and the unstructured document are used as input to a table structured component. Finally, at operation 320, the table structured component generates a structured representation of the table.

For example, the object detection model processes the input received at operation 305 and generates location information at operation 310. This location information includes the predicted bounding boxes for table cells, along with their classification as headers or non-headers. The object detection model, such as YOLOX, utilizes the page, text, image, vector, and Font-Info channels to accurately identify and locate table components within the unstructured document.

For example, at operation 315, the location information generated by the object detection model, along with the original unstructured document, are used as input to a table structured component. This component is responsible for analyzing the location information and the document's content to determine the relationships between table cells, headers, rows, and columns.

For example, at operation 320, the table structured component generates a structured representation of the table based on the input received at operation 315. This structured representation organizes the table's content into a logical, machine-readable format, capturing the hierarchical relationships between table elements. The structured representation serves as the output of the table decomposition process and can be utilized for various downstream applications.

Referring to FIG. 3, the structured representation obtained from the table decomposition process has a plurality of applications in the context of unstructured documents like PDFs. In some examples, the structured representation enables content extraction with relevant Row or Column information. In some examples, the structured representation facilitates the conversion of PDFs to HTML. In some examples, the availability of a structured table representation enhances the generation of document summaries and enables question-answering capabilities for tables within PDF documents, particularly in GenAI-based PDF workflows. Embodiments of the present disclosure demonstrate improvements over some methods in terms of latency and quality of table decomposition.

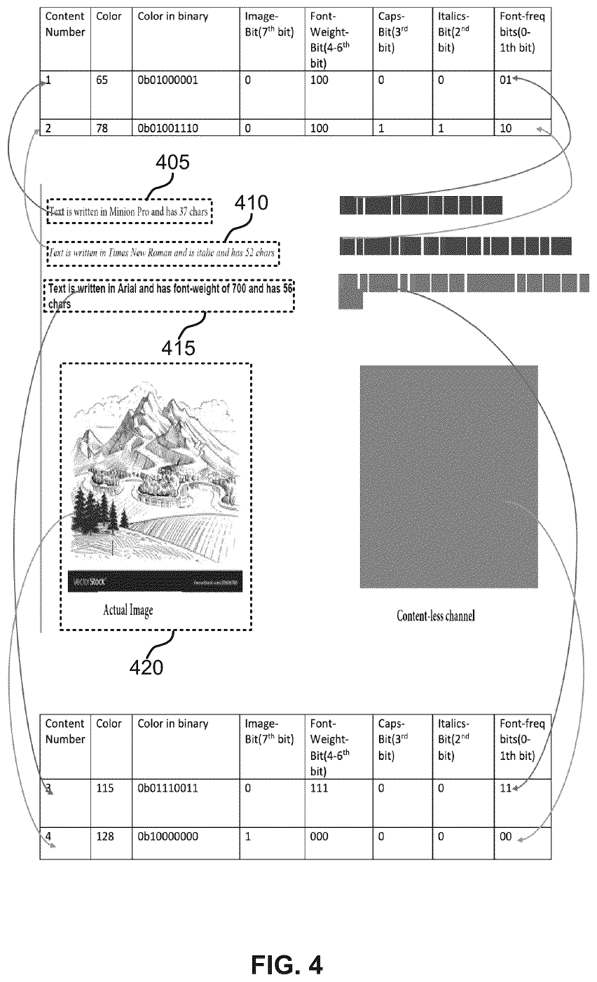

FIG. 4 shows an example of font information encoding method 400 according to aspects of the present disclosure. The font information encoding method 400 is an example of, or includes aspects of, the corresponding element described with reference to FIGS. 1-3, 5, 6, and 9.

Referring to FIG. 4, the first line 405, written in Minion-pro with 37 characters, corresponds to Content 1. Content 1 is the character ‘t’ of the word ‘Text’. The second line 410, written in Times New Roman with 52 characters, corresponds to Content 2. Content 2 is the character ‘T’ of the word ‘Text’. The third line 415, written in Arial with 56 characters, corresponds to Content 3. Content 3 is the character ‘w’ of the word ‘written’. Element 420 corresponds to Content 4. Content 4 is an actual image.

Referring to FIG. 4, the content in the document is replaced with rectangles and filled with colors (grayscale from 0-255). For example, Bit-7 is set if the document element is an image, and the remaining bits [0-6] are all set to 0. Bits [4-6] are only set if the document element is a character, and their value is calculated using the formula min (max (fontWeight, 200), 700)/100% 8, which maps the font weight into 3 bits.

In this example, Bit-3 is set if the character is in uppercase (CAPS), and bit-2 is set if the character is in italics. Bits [0-1] are used to depict the change in font and font frequency on a page. In this example, the most frequently used font on the page is encoded as 11, the second most used font is encoded as 10, the third most used font is encoded as 01, and the remaining fonts, if any, are encoded as 00.

Referring to FIG. 4, the left-hand side of FIG. 4 shows the image of the document, while the right-hand side shows the newly added channel. The first line 405 is written in Minion-pro with 37 characters, the second line 410 is written in Times New Roman with 52 characters, and the third line 415 is written in Arial with 56 characters, followed by element 420. The content in the document is mapped to the actual coloring in the new channel.

Content 1 is the character ‘t’ of the word ‘Text’ on the first line 405. Since Minion-Pro is the third most used font on the page, bits [0-1] are set to 01. As it is not in uppercase, italics, or an image, bits 7, 3, and 2 are set to 0. The font-weight is 400, and bits [4-6] are set using the formula min (max (fontWeight, 200), 700)/100% 8, resulting in a value of 4 (100 in binary).

Content 2 is the character ‘T’ of the word ‘Text’ on the second line 410. In this example, Times New Roman is the 2nd most used font on the page, so bits [0-1] are set to 10. Because the character ‘T’ is not an image, bit-7 is set to 0. Because the character ‘T’ is in uppercase, bit-3 is set to 1. Because the character ‘T’ in the second line 410 is in italics, bit-2 is set to 1. The font-weight is 400, and bits [4-6] are set using the same formula as Content 1, resulting in a value of 4 (i.e., 100 in binary).

Content 3 is the character ‘w’ of the word ‘written’ on the third line 415. In this example, Arial is the most used font on the page, so bits [0-1] are set to 11. Because the character ‘w’ is not in italics, uppercase, or an image, bits 2, 3, and 7 are set to 0. The font-weight is 700, and bits [4-6] are set using the formula min (max (fontWeight, 200), 700)/100% 8, resulting in a value of 7 (111 in binary). Content 4 is an actual image corresponding to element 420, so bit-7 is set to 1, and the remaining bits are set to 0.

According to some embodiments, encoding the Font-Info channel is effective because in many cases table headers are written with different font names and styles (italic, bold, or uppercase). Explicitly encoding these attributes facilitates the model to identify and distinguish these table headers. According to some embodiments, the model trained with additional channel achieves a better F1 score for table headers.

### Language Processing Apparatus

An apparatus for language processing is described. One or more aspects of the apparatus include at least one processor; at least one memory storing instruction executable by the at least one processor; and an object detection model comprising parameters stored in the at least one memory and trained to generate location information for an element of a table of an unstructured document based on font information of the unstructured document.

Some examples of the apparatus and method further include wherein the object detection model comprise a feature pyramid network. Some examples of the apparatus and method further include a table structured component configured to generate a structured representation of the table based on the location information. Some examples of the apparatus and method further include a document editing component configured to modify a border of a table based on the location information.

FIG. 5 shows an example of a language processing apparatus 500 according to aspects of the present disclosure. The language processing apparatus 500 is an example of, or includes aspects of, the corresponding element described with reference to FIGS. 1-4, 6, and 9.

FIG. 5 shows an example of a language processing apparatus 500 according to aspects of the present disclosure. Image processing apparatus 500 is an example of, or includes aspects of, the corresponding element described with reference to FIG. 1. In one aspect, the language processing apparatus 500 includes processor unit 505, I/O module 510, training component 515, memory unit 520, machine learning model 525 including object detection model 530, table structured component 535, and document editing component 540.

Processor unit 505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

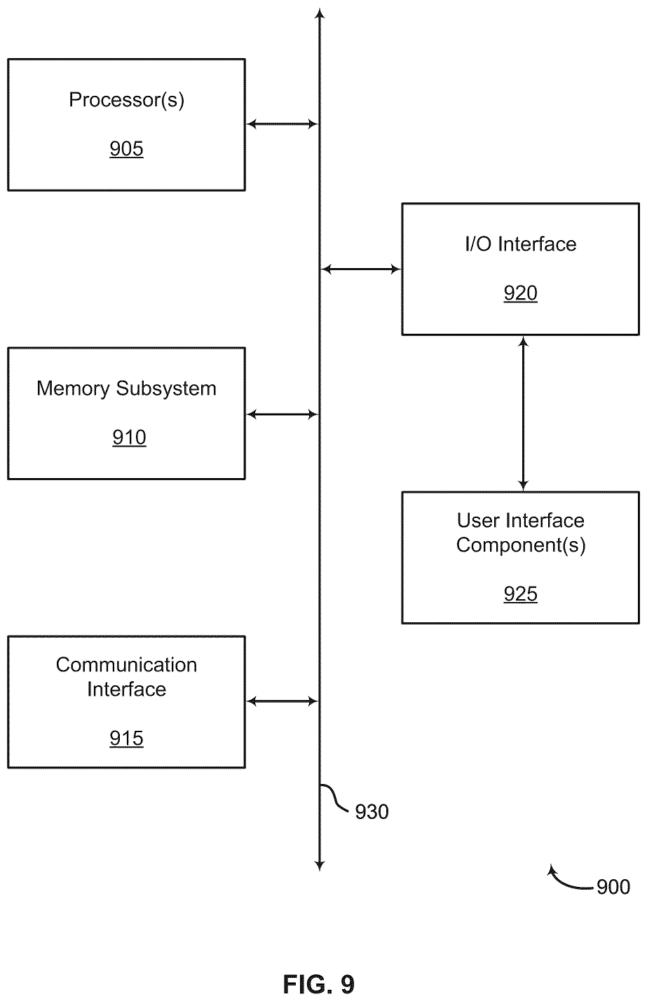

In some cases, processor unit 505 is configured to operate a memory array using a memory controller. In other cases, a memory controller is integrated into processor unit 505. In some cases, processor unit 505 is configured to execute computer-readable instructions stored in memory unit 520 to perform various functions. In some aspects, processor unit 505 includes special purpose components for modem processing, baseband processing, digital signal processing, or transmission processing. According to aspects, processor unit 505 comprises one or more processors described with reference to FIG. 9.

Memory unit 520 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 505 to perform various functions described herein.

In some cases, memory unit 520 includes a basic input/output system (BIOS) that controls basic hardware or software operations, such as an interaction with peripheral components or devices. In some cases, memory unit 520 includes a memory controller that operates memory cells of memory unit 520. For example, the memory controller may include a row decoder, column decoder, or both. In some cases, memory cells within memory unit 520 store information in the form of a logical state. According to aspects, memory unit 520 comprises the memory subsystem described with reference to FIG. 9.

According to aspects, image processing apparatus 500 uses one or more processors of processor unit 505 to execute instructions stored in memory unit 520 to perform functions described herein. For example, in some cases, the image processing apparatus 500 obtains a prompt describing an image element. For example, the image element may be corresponding to a plurality of concepts.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the neural network's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to aspects, object detection model 530 is included in the system 500. The object detection model 530 is responsible for analyzing the unstructured document and font information to generate location information for table elements.

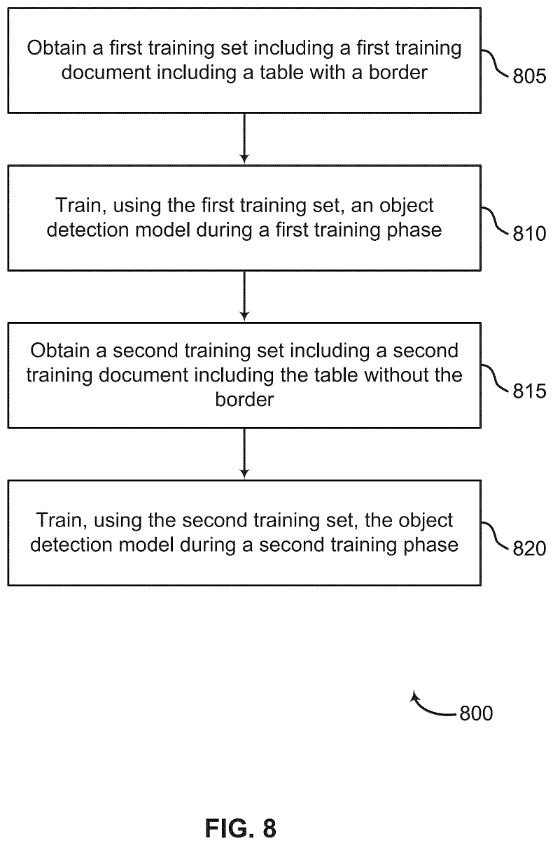

The object detection model 530 is trained using a two-phase approach, as described in FIG. 8. In the first phase, the model learns to detect table elements based on a training set containing bordered tables. This allows the model to learn the basic structure and visual cues associated with table layouts. In the second phase, the model is further trained using a training set containing tables without borders, enabling it to generalize to a wider range of table styles and formats.

The object detection model 530 outputs location information in the form of bounding boxes. The bounding boxes may outline the positions and dimensions of each detected table element within the document. This location information may be used for the subsequent steps in the table extraction process.

According to aspects, table structured component 535 is included in the system 500 to generate a structured representation of the table based on the location information provided by the object detection model 530. The table structured component 535 takes the bounding boxes and other spatial data as input and organizes the detected table elements into a logical, machine-readable format.

Table structured component 535 analyzes the relationships between the detected cells, headers, and other table components to determine the overall structure of the table. Table structured component 535 identifies the rows and columns, associates cells with their corresponding headers, and handles spanning cells (i.e., cells that span multiple rows or columns). In some examples, by processing the location information, table structured component 535 creates a structured representation that captures the hierarchical nature of the table and enables efficient data extraction and manipulation.

The document editing component 540 is included in system 500 to facilitate the editing and manipulation of the extracted table data. The document editing component 540 provides a user interface and a set of tools that allow users to interact with the structured table representation generated by the table structured component 535.

The document editing component 540 enables users to perform various operations on the extracted table, such as modifying cell contents, merging or splitting cells, adding or deleting rows and columns, and applying formatting changes. In some examples, document editing component 540 provides a user-friendly way to refine and customize the extracted table data to suit specific needs or requirements.

FIG. 6 shows demonstrated results 600 of multiple language processing methods according to aspects of the present disclosure. The demonstrated results 600 is an example of, or includes aspects of, the corresponding element described with reference to FIGS. 1-5, and 9.

Some methods employ a transformer-based object detection model to identify bounding boxes for rows, columns, and spanning cells. However, these methods do not directly detect all table cells and rely on heuristics to convert the predicted bounding boxes to table cells, resulting in inferior table decomposition quality compared to the method proposed in the present disclosure. In some cases, these methods detect projected row headers (i.e., row headers that span across columns) and do not detect all row header cells.

Some other methods comprise a pair of deep learning models that predict the basic table grid pattern and merge grid elements to recover cells spanning multiple rows or columns. However, these methods may have high latency due to the sequential execution of multiple models for the split task and the merge task. In some examples, these methods do not detect row header cells at all.

Referring to FIG. 6, a comparison of the results obtained according to embodiments of the present disclosure and the results obtained based on some other methods is demonstrated. In this demonstration, the dataset comprises 4,393 tables (1,745 bordered tables, 1,671 hybrid tables, and 909 open tables). The comparison is based on a plurality of metrics, including mAP, Table-Header F1, and % of perfect tables.

For example, for mAP (mean Average Precision), a higher value indicates better performance. For example, Table-Header F1, by using a header confidence threshold of 0.5 (i.e., any cell with a row or column header probability>0.5 is classified as a header) and an IoU (Intersection over Union) threshold of 0.5, the F1 score is computed for bounding boxes predicted corresponding to the table_cell class. For example, the % of perfect tables represents the percentage of tables with a fully correct structure (excluding header classification) in the tagged PDF (i.e., all content items are assigned to the appropriate table cells). A higher percentage is better.

As shown in FIG. 6, column 605 shows the performance of Table Transformer, column 610 shows the performance of DTM, and columns 615, 620, and 625 show the performance of the method according to embodiments of the present disclosure. Column 615 represents the base model, column 620 represents the base model with the font-info channel, and column 625 represents the base model with the font-info channel and augmentation.

The results demonstrate that the method according to embodiments of the present disclosure (columns 615, 620, and 625) outperforms both Table Transformer and DTM in these three metrics. The performance of the embodiments of the present disclosure improves from the base model in column 615 to the base model with the font-info channel in column 620 and further improves with the addition of augmentation in column 625. This indicates that the incorporation of the font-info channel and data augmentation techniques enhances the table decomposition quality and overall performance of the embodiments of the present disclosure compared to some methods.

### Language Processing Method

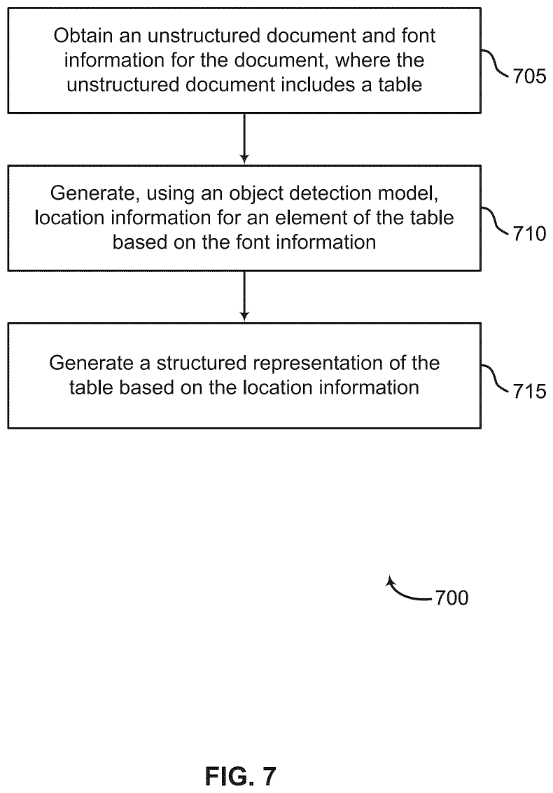

FIG. 7 shows an example of a method 700 method for language processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains an unstructured document and font information for the document, where the unstructured document includes a table. In some cases, the operations of this step refer to, or may be performed by, an object detection model as described with reference to FIG. 5.

In some examples, at operation 705, the unstructured document can be in various formats, such as PDF, which lacks explicit structural information about the content. The system extracts the raw text and visual elements from the document, including tables. The font information obtained alongside the unstructured document includes details about the typefaces, styles, and sizes used throughout the document. In some examples, the information may be used for the object detection model to differentiate between various elements of the table, such as headers and regular cells, based on different font attributes corresponding to the headers and regular cells.

At operation 710, the system generates, using an object detection model, location information for an element of the table based on the font information. In some cases, the operations of this step refer to, or may be performed by, an object detection model as described with reference to FIG. 5.

In some examples, the object detection model may be YOLOX. YOLOX is a modified version of YOLO. The object detection model processes the unstructured document and font information to identify and localize table elements. For example, the YOLOX predicts bounding boxes for each table cell and classifies them as either headers or regular cells based on the font attributes and spatial arrangement.

The location information for an element of the table refers to the spatial coordinates and dimensions that define the position and extent of a specific table component within the document. The location information may be used for the system to accurately identify and extract the content of individual table cells, headers, rows, and columns.

In some examples, table headers may have distinct font styles, such as bold or italicized text, compared to regular cells. At operation 710, by incorporating font information into the object detection model, the system can more accurately distinguish between different types of table elements and generate precise location information.

At operation 715, the system generates a structured representation of the table based on the location information. In some cases, the operations of this step refer to, or may be performed by, a table structured component as described with reference to FIG. 5.

In some examples, at operation 715, the table structured component takes the location information generated by the object detection model and transforms the location information into a structured format. For example, this process involves organizing the detected table cells into a logical grid structure.

In some examples, the structured representation preserves the relationships between table elements, such as which cells belong to the same row or column and which cells are headers. The structured representation provides a clear and machine-readable representation of the table's structure and hierarchy. The structured for representation may be further used for efficient data extraction, analysis, and further processing of the table content.

### Method for Training a Machine Learning Model

One or more aspects of the method include obtaining a first training set comprising a first training document including a table with a border; training, using the first training set, an object detection model during a first training phase; obtaining a second training set comprising a second training document including the table without the border; and training, using the second training set, the object detection model during a second training phase.

Some examples further include generating location information for an element of the table using the object detection model. Some examples further include removing the border from the first training document based on the location information based on the first training document. Some examples further include determining that the object detection mislabeled an element of the table from the second training document.

Some examples further include randomly selecting one of the first training document and the second training document for the first training set. Some examples further include obtaining training font information for the first training document, wherein the objection detection model is trained based on the training font information.

Some examples of the method, apparatus, and non-transitory computer readable medium further include generating predicted location information for an element of the table. Some examples further include comparing the predicted location information to ground truth information for the element of the table. Some examples further include updating parameters of the object detection model based on the comparison.

Some examples of the method, apparatus, and non-transitory computer readable medium further include training the object detection model to predict a cell boundary for a cell of the table. Some examples of the method, apparatus, and non-transitory computer readable medium further include training the object detection model to predict a header classification for an element of the table.

In one aspect, in one aspect, embodiments of the present disclosure leverage unlabeled data to improve the performance of table detection and structure recognition on open and hybrid tables. The method takes advantage of the strong signal provided by the presence of vertical and horizontal lines in bordered tables, which enables accurate table detection and structure recognition. By applying the disclosed technique to millions of bordered tables from unlabeled PDFs, the method generates high-quality training data for open and hybrid tables.

According to some embodiments, the method involves using a previous version of the table detection and structure recognition model to weak-label bordered tables from unlabeled PDFs. The horizontal and vertical lines of these bordered tables are then deleted to create images that resemble open and hybrid tables. The method may apply a set of heuristics to ensure that only pages with perfectly predicted bordered tables are considered and that the deletion of lines results in images that closely resemble open and hybrid tables. Furthermore, the method filters the augmented images to be added to the training dataset based on the prediction accuracy on the non-augmented images, ensuring that only high-quality training data is used to improve the model's performance.

An example algorithm for generating the training data includes the following steps: (1) Filter pages from DeepReservoir which have only border tables; (2) Infer table cells on these pages using Neptune; (3) Ignore page(s) for further processing if number of cells in table<threshold (=5), empty cells in table, cells do not fill the table box area completely, lowest table cell probability<threshold (=0.75), considerable overlap between any two cells, and just single column/row in table; (4) Generate corresponding augmented page(s) by removing horizontal and vertical beams from the bordered table using pdfRender; (5) Infer table cells on the augmented page(s) using Neptune; (6) Ignore page(s) for further processing if 5-percentile of table cell probability distribution on open table>threshold (=0.8); (7) Assign a difficulty score to each page based on the level of cell mismatch between predictions on bordered and corresponding open table, and the Table Cell Probability Distribution on Open Table; (8) Add pages above a certain difficulty score to model training dataset.

In this example, by incorporating this algorithmically generated training data, embodiments of the present disclosure significantly improve the performance of table detection and structure recognition on open and hybrid tables, which have been challenging for some methods due to factors including lack of explicit visual cues. The method enables the creation of a large, high-quality dataset for training the model, leading to enhanced accuracy and robustness in real-world scenarios.

FIG. 8 shows an example of method 800 for training a language processing model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains a first training set including a first training document including a table with a border. In some cases, the operations of this step refer to, or may be performed by, a training component as described with reference to FIG. 5.

In some examples, the first training set includes a collection of documents, and a document may include at least one table with a border. These bordered tables may be used as the initial training data for the object detection model. For example, the borders may provide clear visual cues for the model to learn the structure and boundaries of the table cells.

In some examples, the training component preprocesses the training documents, such as converting the training documents into a suitable format (e.g., images) and extracting relevant features, including the font information. This process transforms the initial input data and prepares the data for the subsequent training phase.

At operation 810, the system trains, using the first training set, an object detection model during a first training phase. In some cases, the operations of this step refer to, or may be performed by, a training component as described with reference to FIG. 5.

In some examples, during the first training phase, the object detection model, such as YOLO or YOLOX, is trained using the bordered table dataset obtained in operation 805. The model learns to recognize and localize table cells based on the visual cues provided by the borders. For example, the training process involves optimizing the model's parameters to minimize the difference between its predictions and the ground truth annotations. This optimization may be achieved through techniques like stochastic gradient descent and backpropagation.

At operation 815, the system obtains a second training set including a second training document including the table without the border. In some cases, the operations of this step refer to, or may be performed by, a training component as described with reference to FIG. 5.

In some examples, the second training set includes tables without borders. These tables lack the explicit visual cues provided by borders. The training component may prepare the second training set by either manually annotating borderless tables or algorithmically removing the borders from the tables in the first training set. In some examples, this process creates a diverse dataset that includes both bordered and borderless tables.

At operation 820, the system trains, using the second training set, the object detection model during a second training phase. In some cases, the operations of this step refer to, or may be performed by, a training component as described with reference to FIG. 5.

In some examples, in the second training phase, the object detection model is further trained using the borderless table dataset obtained in operation 815. At operation 820, the model learns to rely on other visual cues, such as font information and spatial arrangement, to detect and localize table cells in the absence of borders.

In some examples, at operation 820, by exposing the model to a variety of table styles and structures during the two training phases, the system trains an object detection model that can handle both bordered and borderless tables. This process may increase the model's generalization ability and performance on real-world documents with diverse table layouts.

FIG. 9 shows an example of a computing device 900 according to aspects of the present disclosure. The computing device 900 is an example of, or includes aspects of, the corresponding element described with reference to FIGS. 1-6. The computing device 900 includes processor(s) 905, memory subsystem 910, communication interface 915, I/O interface 920, user interface component(s) 925, and channel 930.

In some embodiments, computing device 900 is an example of, or includes aspects of, the image generation apparatus described with reference to FIGS. 1-6. In some embodiments, computing device 900 includes one or more processors 905 that can execute instructions stored in memory subsystem 910 to generate synthetic images comprising a first attribute and a second attribute by providing a first attribute token to a first set layers of the image generation model during a first set of time-steps and providing a second attribute token to a second set of layers of the image generation model during a second set of time-steps

According to some aspects, computing device 900 includes one or more processors 905. Processor(s) 905 are an example of, or includes aspects of, the processor unit as described with reference to FIG. 5. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 910 includes one or more memory devices. Memory subsystem 910 is an example of, or includes aspects of, the memory unit as described with reference to FIG. 5. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 915 operates at a boundary between communicating entities (such as computing device 900, one or more user devices, a cloud, and one or more databases) and channel 930 and can record and process communications. In some cases, communication interface 915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 920 is controlled by an I/O controller to manage input and output signals for computing device 900. In some cases, I/O interface 920 manages peripherals not integrated into computing device 900. In some cases, I/O interface 920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 920 or via hardware components controlled by the I/O controller.

According to some aspects, user interface component 925 enables a user to interact with computing device 900. In some cases, user interface component 925 includes an audio device, such as an external speaker system, an external display device such as a display screen, an input device (e.g., a remote-control device interfaced with a user interface directly or through the I/O controller), or a combination thereof. In some cases, user interface component 925 includes a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an unstructured document and font information for the document, wherein the unstructured document includes a table;
generating, using an object detection model, location information for an element of the table based on the font information; and
generating a structured representation of the table based on the location information.

2. The method of claim 1, wherein obtaining the font information comprises:
performing text recognition on the unstructured document.

3. The method of claim 1, wherein:
the location information for the element of the table comprises a bounding box of a cell of the table.

4. The method of claim 1, further comprising:
predicting, using the object detection model, a header classification for the element of the table.

5. The method of claim 1, wherein:
the structured representation includes row information, column information, and cell content information for the table.

6. The method of claim 1, further comprising:
modifying a border of the table based on the structured representation.

7. The method of claim 1, wherein:
the object detection model is trained to detect table elements using a training set comprising training font information.

8. The method of claim 1, wherein:
the object detection model is trained to detect table elements in a first training phase using a first training set comprising a first training document including a table and in a second training phase using a second training set comprising a second training document including the table without the border.

9. A method for training a machine learning model, the method comprising:
obtaining a first training set comprising a first training document including a table with a border;
training, using the first training set, an object detection model during a first training phase;
obtaining a second training set comprising a second training document including the table without the border; and
training, using the second training set, the object detection model during a second training phase.

10. The method of claim 9, where obtaining the second training set comprises:
generating location information for an element of the table using the object detection model; and
removing the border from the first training document based on the location information based on the first training document.

11. The method of claim 9, where obtaining the second training set comprises:
determining that the object detection mislabeled an element of the table from the second training document.

12. The method of claim 9, where obtaining the first training set comprises:
randomly selecting one of the first training document and the second training document for the first training set.

13. The method of claim 9, where obtaining the first training set comprises:
obtaining training font information for the first training document, wherein the objection detection model is trained based on the training font information.

14. The method of claim 9, where training the object detection model comprises:
generating predicted location information for an element of the table;
comparing the predicted location information to ground truth information for the element of the table;
updating parameters of the object detection model based on the comparison.

15. The method of claim 9, where training the object detection model comprises:
training the object detection model to predict a cell boundary for a cell of the table.

16. The method of claim 9, where training the object detection model comprises:
training the object detection model to predict a header classification for an element of the table.

17. An apparatus comprising:
at least one processor;
at least one memory storing instruction executable by the at least one processor; and
an object detection model comprising parameters stored in the at least one memory and trained to generate location information for an element of a table of an unstructured document based on font information of the unstructured document.

18. The apparatus of claim 17, where the object detection model comprises a feature pyramid network.

19. The apparatus of claim 17, further comprising:
a table structured component configured to generate a structured representation of the table based on the location information.

20. The apparatus of claim 17, further comprising:
a document editing component configured to modify a border of a table based on the location information.
